(19) United States
(12) Patent Application Publication
(10) Pub. No.: US 2015/0219503 A1
(43) Pub. Date: Aug. 6, 2015

(54) TEMPERATURE DETECTING DEVICE

(71) Applicant: Tatsuya YOSHIDA, Tokyo (JP)

(72) Inventor: Tatsuya YOSHIDA, Tokyo (JP)

(21) Appl. No.: 14/606,291

(22) Filed: Jan. 27, 2015

(30) Foreign Application Priority Data
Feb. 3, 2014 (JP) 2014-018590

(51) Int. Cl. G01K 7/24; G05B 11/01; H01C 7/00

(52) U.S. Cl. CPC G01K 7/24; H01C 7/008; G05B 11/01

(57) ABSTRACT

A temperature detecting device adapted to detect temperature based on output voltage at a connection point of a thermistor and a voltage-dividing resistor, includes a temperature estimator to estimate temperature of the thermistor, a supply voltage regulator to regulate voltage supplied to the thermistor, a voltage dividing resistance regulator to regulate resistance of the voltage-dividing resistor, and a switching controller to determine whether the estimated temperature of the thermistor is in a high or low-temperature range and to control the regulators simultaneously based on the determination.

### CROSS-REFERENCE TO RELATED APPLICATIONS

The present application is based on and claims priority from Japanese Patent Application Number 2014-018590, filed Feb. 3, 2014, the disclosure of which is hereby incorporated by reference herein in its entirety.

### BACKGROUND

The present invention relates to a temperature detecting device equipped with a thermistor whose resistance varies with temperature.

In a temperature detecting device equipped with a thermistor, the thermistor is directly connected with a voltage-dividing resistor, and the temperature inside of an apparatus including the thermistor is detected by measuring (detecting) voltage at a connection point of the thermistor and the voltage-dividing resistor.

For example, an outside monitoring camera being installed outside and having a zoom lens includes a temperature detecting device to detect temperature inside the camera. This type of camera includes a circuit board to drive the zoom lens, and the temperature inside the camera is affected by the heat generated by semi-conductors on the circuit board and/or ambient temperature and so on.

In general, temperature-resistance characteristics (temperature versus resistance characteristics) of the thermistor show a non-linear relationship. For instance, detection accuracy at relatively high temperature decreases compared with the detection accuracy at relatively low temperature (i.e., the detection accuracy in a low-temperature range is higher (better) than the detection accuracy in a high-temperature range), or vice versa (i.e., the detection accuracy at low temperature decreases compared with the detection accuracy at high temperature).

In order to prevent the detection accuracy from decreasing, Japanese Patent Application Publication No. 2009-121825 suggests a temperature detecting device configured to have two kinds of voltage-dividing resistors and to select one of the voltage-dividing resistors depending on whether the subject temperature is relatively high or low.

### SUMMARY

However, in a temperature detecting device configured to select (changeover) the voltage-dividing resistors as suggested by the above document, it is possible to have an error caused by self-heating of the thermistor if a current value is increased in a low-resistance range in which the detection accuracy is low. To be more specific, since the thermistor has a built-in resistor, it generates heat (joule heat) when current flows through the thermistor. As is known, the generated self-heating amount is proportional to the square of the current value (i.e., the generated self-heating amount is greatly influenced by an increase amount of the current value). For example, when the current value is doubled, the generated self-heating amount is quadrupled, when the current value is tripled, the generated self-heating amount is increased nine times, and so on. As a result, the accuracy of detecting temperature using the thermistor in the low-resistance range decreases.

Here, since the thermistor itself has a resistance value which varies with temperature, the heating amount is, to be more precise, a sum of a heating amount generated by the ambient temperature and the self-heating amount.

An object of the embodiments of this invention is, therefore, to provide a temperature detecting device which enables detection of temperature accurately even in the low-resistance range.

In order to achieve the above object, an embodiment of the present invention provides a temperature detecting device including a thermistor and a voltage-dividing resistor directly connected to the thermistor and being adapted to detect temperature based on output voltage at a connection point of the thermistor and the voltage-dividing resistor, the device comprising a temperature detector to detect temperature of the thermistor; a supply voltage regulator to regulate voltage supplied from a voltage source to the thermistor; a voltage dividing resistance regulator to regulate a resistance value of the voltage-dividing resistor; and a switching controller to determine whether the detected temperature of the thermistor is in a high-temperature range or in a low-temperature range, and to control the supply voltage regulator and the voltage dividing resistance regulator simultaneously based on the determination.

### BRIEF DESCRIPTION OF THE DRAWINGS

FIG. 1 is a circuit diagram showing a general configuration of a temperature detecting device in which a thermistor and a voltage-dividing resistor are directly connected;

FIG. 2 is a diagram showing temperature versus resistance characteristics of an NTC thermistor;

FIG. 3 is a diagram showing variation of thermistor resistance in response to temperature T₀, T₀₊₁, T₀₊₂, T₀₊₃, T₀₋₁, and T₀₋₂ on the curve C of FIG. 2;

FIG. 4 is a diagram showing resolution of the thermistor in relation to the voltage dividing resistance;

FIG. 5 is a circuit diagram showing the overall configuration of the temperature detecting device of Embodiment 1 and for explaining operation of the device when the thermistor temperature is low;

FIG. 6 is a circuit diagram for explaining operation of the device in FIG. 5 when the thermistor temperature is high;

FIG. 7 is a diagram showing temperature versus resistance characteristics of a PTC thermistor;

FIG. 8 is a circuit diagram showing the overall configuration of the temperature detecting device of Embodiment 2 and for explaining operation of the device when the thermistor temperature is low; and

FIG. 9 is a circuit diagram for explaining operation of the device in FIG. 8 when the thermistor temperature is high.

### DETAILED DESCRIPTION OF THE PREFERRED EMBODIMENTS

Hereinafter, a temperature detecting device according to embodiments of the present invention will be explained with reference to the drawings.

### Embodiment 1

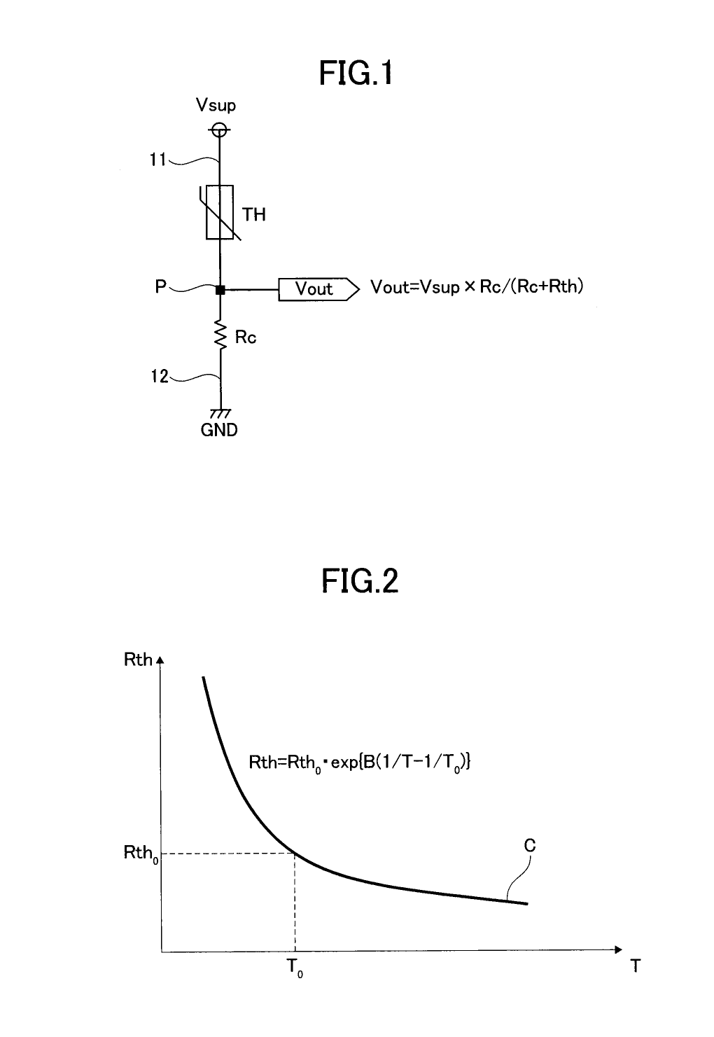

FIG. 1 is a circuit diagram showing a general configuration of a temperature detecting device 10 which is equipped with a thermistor and a voltage-dividing resistor. The temperature detecting device 10 is configured to connect the thermistor TH and the voltage-dividing resistor Rc directly, and to obtain output voltage Vout at a connection point P where the thermistor TH and the voltage-dividing resistor are connected. Here, a terminal 11 of the thermistor TH located opposite to the connection point P is connected to a voltage source, and supply voltage Vsup is applied to the terminal 11. Further, a terminal 12 of the voltage-dividing resistor Rc located opposite to the connection point P is earthed, and voltage at the terminal 12 is set as a ground voltage GND.

Note that in Embodiment 1, the thermistor TH is constituted by an NTC thermistor.

As is known, a current value (I) at the thermistor TH and a current value at the voltage-dividing resistor (fixed resistor) Rc are the same and expressed as I=Vsup/(Rc+Rth), where Vsup is the supply voltage to the thermistor TH, Rth is thermistor resistance (resistance of the thermistor TH) at a certain temperature, and Rc is resistance of the voltage-dividing resistor (fixed resistance). Using Ohm's law (V=IR), the output voltage Vout at the connection point P is represented by the following equation (1):

Vout=Vsup×Rc/(Rc+Rth) (1)

To be specific, although there is another circuit located downstream of the illustrated circuit in order to detect the output voltage Vout, since its input resistance is very large compared with the resistances of Rc or/and Rth, current flowing through this circuit is so small that it can be omitted in the above equation.

As explained above, the thermistor TH itself has resistance Rth which varies with temperature, and the temperature-resistance characteristics show a non-linear relationship. For example, in a case where a negative temperature coefficient thermistor (NTC thermistor) is used as the thermistor TH, the characteristics can be expressed by the curve C, as shown in FIG. 2.

Using the curve C, if the thermistor resistance at temperature T₀ [K] (boundary temperature, explained later) is Rth₀, the thermistor resistance Rth at temperature T [K] is represented by the following equation (2):

Rth=Rth₀·exp{B(1/T−1/T₀)} (2)

where B is a constant (thermistor constant) varying with each thermistor.

As shown in FIG. 2, inclination (negative inclination) of the curve C in the low-temperature range (explained later) is larger (steeper) than inclination in the high-temperature range (explained later), i.e., the accuracy of detecting temperature in the high-temperature range with this type of thermistor (NTC thermistor) decreases compared with the accuracy in the low-temperature range.

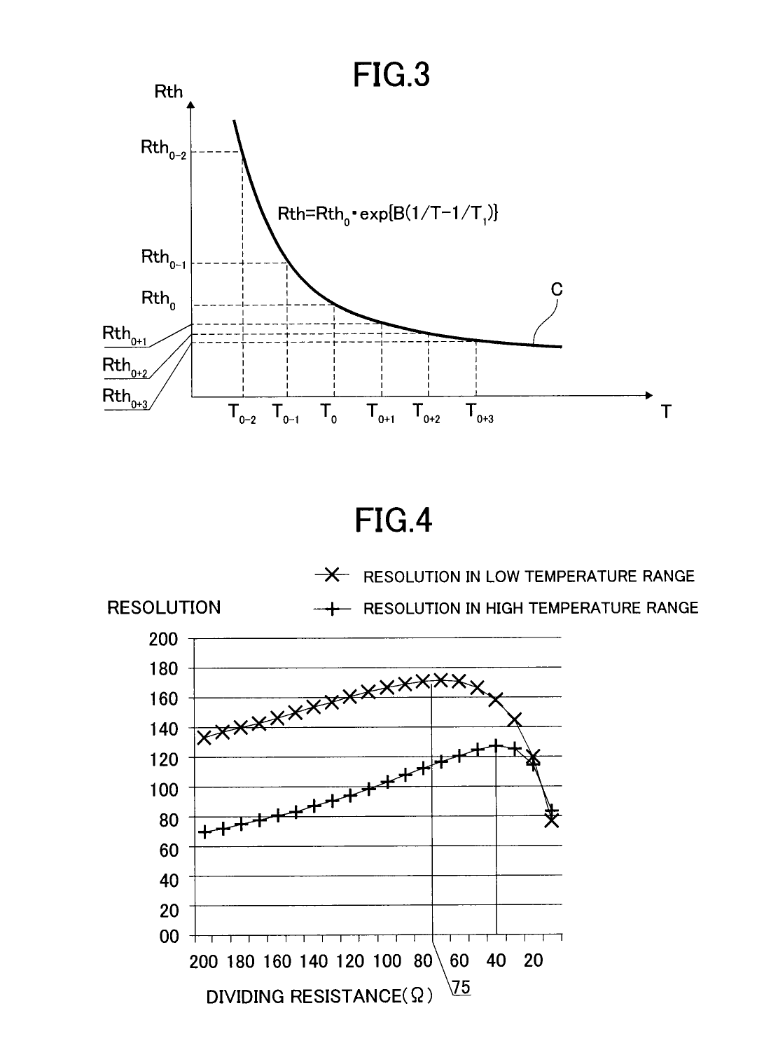

The details will be explained. FIG. 3 is a diagram (graph) showing variation of the thermistor resistance Rth respectively in response to each temperature T₀, T₀₊₁, T₀₊₂, T₀₊₃, T₀₋₁, and T₀₋₂ on the curve C of FIG. 2. Note that each temperature is evenly or equally arranged in FIG. 3. The temperature T₀₋₂ corresponds to the resistance Rth₀₋₂, the temperature T₀₋₁ corresponds to the resistance Rth₀₋₁, the temperature T₀₊₁ corresponds to the resistance Rth₀₊₁, the temperature T₀₊₂ corresponds to the resistance Rth₀₊₂, the temperature T₀₊₃ corresponds to the resistance Rth₀₊₃, and the temperature T₀ corresponds to the resistance Rth₀.

As illustrated, the changing rate (rate of decrease) from Rth₀₋₂ to Rth₀₋₁ between T₀₋₂ and T₀₋₁ is large, and the changing rate (rate of decrease) from Rth₀₋₁ to Rth₀ between T₀₋₁ and T₀ is relatively large. In contrast, the changing rate (rate of decrease) from Rth₀ to Rth₀₊₁ between T₀ and T₀₊₁ is relatively small, the changing rate (rate of decrease) from Rth₀₊₁ to Rth₀₊₂ between T₀₊₁ and T₀₊₂ is small, and the changing rate (rate of decrease) from Rth₀₊₂ to Rth₀₊₃ between T₀₊₂ and T₀₊₃ is even smaller.

That is to say, as shown in FIG. 3, the changing rate is large (i.e., its resolution is high) when the temperature is lower than the boundary temperature To (in this specification, the temperature range lower than the boundary temperature T₀ is called “low-temperature range”), while the changing rate is small (i.e., its resolution is low) when the temperature is higher than the boundary temperature T₀ (in this specification, the temperature range higher than the boundary temperature T₀ is called “high-temperature range”). In other words, the accuracy of detecting the temperature in the high-temperature range decreases compared with the accuracy in the low-temperature range.

As abovementioned, since the temperature-resistance characteristics of the thermistor TH are non-linear, in case of using an NTC thermistor, the resolution in the high-temperature range is lower than the resolution in the low-temperature range if a single reference voltage Vref is used to AD convert the output voltages Vout detected in the low and high-temperature ranges.

Now, a technique to AD convert the output voltages Vout using the reference voltage Vref will be explained.

Each digital data has a resolution (not the resolution regarding the thermistor TH). The 8 bit digital data is expressed with an 8-digit binary number from 00000000B to 11111111B (B represents Binary).

In decimal number, 11111111B becomes 2⁷+2⁶+2⁵+2⁴+2³+2²+2¹+2⁰=128+64+32+16+8+4+2+1=255, and it is said that the resolution of 8 bit digital data is 256. The most significant bit (7th bit) represents a half (½) of its full scale number (to be accurate, it represents 256/2=128), the next bit (6th bit) a quarter (¼) thereof, the next bit (5th bit) an ⅛, the next a 1/16, . . . and 0th bit (the least significant bit) a 1/256.

The function of an AD converter circuit (Analog-to-Digital Converter, hereinafter called “ADC circuit”) of a successive comparison type will be explained as an example.

The ADC circuit of this example can be an independent integrated circuit (IC), or can be one of the functions of a one-chip microcomputer. The ADC circuit works as explained in the following process (1) to (3).

(1) The ADC circuit compares the subject voltage with (Vref/2). When the subject voltage is larger than or equal to (Vref/2), the circuit sets 7th bit to “1” (here, “set” means inputting/writing into/inside a memory). Hence, the result of this comparison is 10000000B in binary number. When the subject voltage is smaller than (Vref/2), the circuit sets 7th bit to “0”. Hence, the result of the comparison becomes 00000000B in binary number.

(2) In a case where the result of the process (1) is “10000000B”, the circuit compares the subject voltage with (Vref/2+Vref/4). When the subject voltage is larger than or equal to (Vref/2+Vref/4), the circuit sets 6th bit to “1”. Hence, the result of the comparison becomes 11000000B in binary number. When the subject voltage is smaller than (Vref/2+Vref/4), the circuit sets 6th bit to “0”. Hence, the result of the comparison becomes 10000000B in binary number.

In contrast, in a case where the result of the process (1) is “00000000B”, the circuit compares the subject voltage with (Vref/4). When the subject voltage is larger than or equal to (Vref/4), the circuit sets 6th bit to “1”. Hence, the result of the comparison becomes 01000000B in binary number. When the subject voltage is smaller than (Vref/4), the circuit sets 6th bit to “0”. Hence, the result of the comparison becomes 00000000B in binary number.

(3) In a case where the result of the process (2) is “11000000B”, the circuit compares the subject voltage with (Vref/2+Vref/4+Vref/8). When the subject voltage is larger than or equal to (Vref/2+Vref/4+Vref/8), the circuit sets 5th bit to “1”. Hence the result of the comparison becomes 11100000B in binary number. When the subject voltage is smaller than (Vref/2+Vref/4+Vref/8), the circuit sets 5th bit to “0”. Hence, the result of the comparison becomes 11000000B in binary number.

In a case where the result of the process (2) is “10000000B”, the circuit compares the subject voltage with (Vref/2+Vref/8). When the subject voltage is greater than or equal to (Vref/2+Vref/8), the circuit sets 5th bit to “1”. Hence, the result of the comparison becomes 10100000B in binary number. When the subject voltage is smaller than (Vref/2+Vref/8), the circuit sets 5th bit to “0”. Hence, the result of the comparison becomes 10000000B in binary number.

In a case where the result of the process (2) is “01000000B”, the circuit compares the subject voltage with (Vref/4+Vref/8). When the subject voltage is greater than or equal to (Vref/4+Vref/8), the circuit sets 5th bit to “1”. Hence, the result of the comparison becomes 01100000B in binary number. When the subject voltage is smaller than (Vref/4+Vref/8), the circuit sets 5th bit to “0”. Hence, the result of the comparison becomes 01000000B in binary number.

Further, in a case where the result of the process (2) is “00000000B”, the circuit compares the subject voltage with (Vref/8). When the subject voltage is greater than or equal to (Vref/8), the circuit sets 5th bit to “1”. Hence, the result of the comparison becomes 00100000B in binary number. When the subject voltage is even smaller than (Vref/8), the circuit sets 5th bit to “0”. Hence, the result of the comparison becomes 00000000B in binary number.

The circuit continues the comparison for 4th, 3rd, 2nd, 1st and 0th bits in the same manner to complete the AD conversion for obtaining binary number 00000000B-11111111B.

FIG. 4 shows the relationship between the resistance of the voltage-dividing resistor Rc and the resolution of the thermistor TH, obtained from an experiment explained later. The upper line (graph) shows the resolution in high-resistance range (resistance range in the low-temperature range), while the lower line (graph) shows the resolution in the low-resistance range (resistance range in the high-temperature range).

Here, the temperature T₀ shows the boundary temperature between the low-temperature range and the high-temperature range. The experiment was carried out under the condition where the thermistor resistance Rth at the lowest temperature Tmin was set to 100Ω, the resistance Rth₀ at the boundary temperature T₀ was set to 50Ω, the resistance at the highest temperature Tmax was set to 30Ω, and the supply voltage Vsup was set to 1V. The results of the experiment are shown in FIG. 4 as well as in the following Table 1.

TABLE 1

| DIVIDING | Vmin | Vo | | Vmax | |
|---|---|---|---|---|---|
| RESISTOR | [V] | [V] | RESOLU- | [V] | RESOLU- |
| Rc[Ω] | @Tmax | @T₀ | TION ≦T₀ | @ Tmax | TION >T₀ |
| 200 | 0.333 | 0.200 | 133 | 0.130 | 70 |
| 190 | 0.345 | 0.208 | 136 | 0.136 | 72 |
| 180 | 0.357 | 0.217 | 140 | 0.143 | 75 |
| 170 | 0.370 | 0.227 | 143 | 0.150 | 77 |
| 160 | 0.385 | 0.238 | 147 | 0.158 | 80 |
| 150 | 0.400 | 0.250 | 150 | 0.167 | 83 |
| 140 | 0.417 | 0.263 | 154 | 0.176 | 87 |
| 130 | 0.435 | 0.278 | 157 | 0.188 | 90 |
| 120 | 0.455 | 0.294 | 160 | 0.200 | 94 |
| 110 | 0.476 | 0.313 | 164 | 0.214 | 98 |
| 100 | 0.500 | 0.333 | 167 | 0.231 | 103 |
| 90 | 0.526 | 0.357 | 169 | 0.250 | 107 |
| 80 | 0.556 | 0.385 | 171 | 0.273 | 112 |
| 70 | 0.588 | 0.417 | 172 | 0.300 | 117 |
| 60 | 0.625 | 0.455 | 170 | 0.333 | 121 |
| 50 | 0.667 | 0.500 | 167 | 0.375 | 125 |
| 40 | 0.714 | 0.556 | 159 | 0.429 | 127 |
| 30 | 0.769 | 0.625 | 144 | 0.500 | 125 |
| 20 | 0.833 | 0.714 | 119 | 0.600 | 114 |
| 10 | 0.909 | 0.833 | 76 | 0.750 | 83 |

As shown, the highest resolution in the high-resistance range (low-temperature range) is obtained when the resistance of the voltage-dividing resistor Rc is 75Ω under the above condition, and the highest resolution in the low-resistance range (high-temperature range) is obtained when the resistance of the voltage-dividing resistor Rc is 40Ω.

Note that the resolution is a relative parameter, and the higher the resolution, the better (i.e., the higher the accuracy). The resolution is calculated as a voltage difference among the output voltage when the thermistor temperature is at the lowest (Vmin), the voltage when the thermistor temperature is at the highest (Vmax), and when the thermistor temperature is at the boundary temperature T₀ (V0) with varying the resistance of the voltage-dividing resistor Rc from 200Ω to 10Ω. To be more specific, the resolutions represent the voltage differences of (voltage at the lowest temperature Vmin−voltage at the boundary temperature V0) for the high-resistance range (low-temperature range) and (voltage at the boundary temperature V0−voltage at the highest temperature Vmax) for the low-resistance range (high-temperature range).

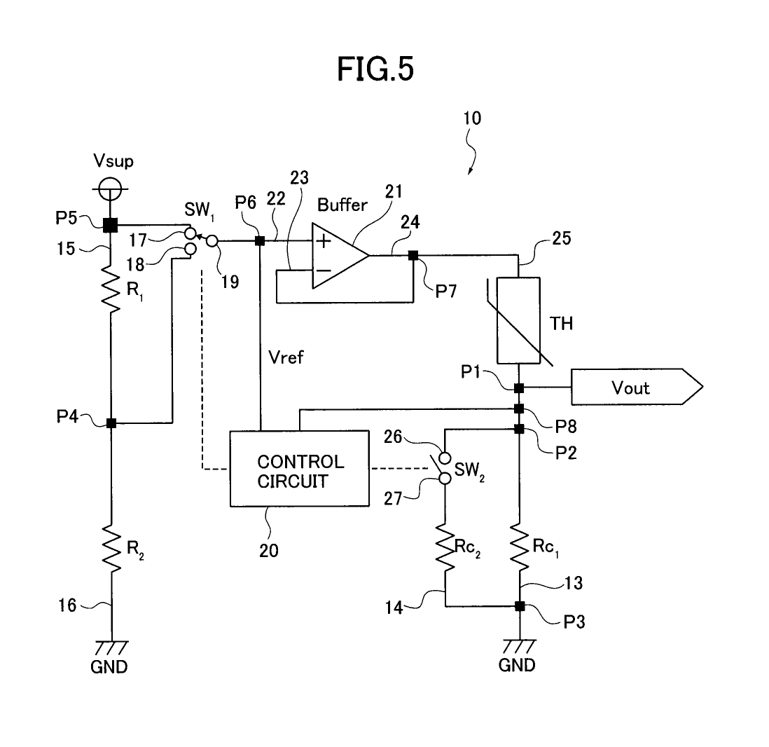

FIG. 5 is a circuit diagram showing the overall configuration of the temperature detecting device 10 of Embodiment 1. As shown in FIG. 5, the thermistor TH is directly connected to parallel-connected voltage-dividing resistors Rc1, Rc2 at a connection point P1. Further, it is configured such that it enables detection of the output voltage Vout at the connection point P1.

The two voltage-dividing resistors Rc1 and Rc2 are connected at connection points P2 and P3 in parallel. An ON/OFF switch SW2 is interposed between the voltage-dividing resistor Rc2 and the connection point P2. Terminals 13, 14 of the voltage-dividing resistors Rc1, Rc2 are connected at the connection point P3 and earthed. Voltage at the terminals 13, 14 is set as a ground voltage GND.

Also, supply voltage-dividing resistors R1 and R2 are directly connected at a connection point P4. The supply voltage Vsup is supplied to a terminal 15 opposite to the connection point P4 of the supply voltage-dividing resistor R1 (The terminal 15 is connected to the voltage source at a connection point P5). Further, a terminal 16 opposite to the connection point P4 of the supply voltage-dividing resistor R2 is earthed, and voltage at the terminal 16 is set to the ground voltage GND.

A changeover switch SW 1 is installed between the thermistor TH and the voltage source. A fixed contact 17 of the changeover switch SW1 is connected to the terminal 15 of the supply voltage-dividing resistor R1 at the connection point P5 and the other fixed contact 18 is connected to the connection point P4 located between the supply voltage-dividing resistors R1, R2. The changeover switch SW1 has a movable contact 19, and the movable contact is controlled by a control signal sent from a control circuit 20. In other words, the movable contact 19 is connected to the fixed contact 17 or to the fixed contact 18 by the changeover switch SW1 depending on the control signal sent from the control circuit 20.

The movable contact 19 of the other end is connected to a non-inverted input terminal 22 of a buffer amplifier (operational amplifier; shown as “Buffer” in FIGS. 5, 6 and 8) 21 through a connection point P6. An output terminal 24 of the buffer amplifier 21 is connected to an input terminal 25 of the thermistor TH at a connection point P7, and the connection point P7 is connected to an inverted input terminal 23 of the buffer amplifier 21.

The ON/OFF switch SW2 directly connected to the voltage-dividing resistor Rc2 has a fixed contact 26 and a movable contact 27 and is controlled to open/close by the control circuit 20. In other words, the movable contact 27 of the ON/OFF switch SW2 is connected to or disconnected from the fixed contact 26 in response to the control signal sent from the control circuit 20.

The control circuit 20 is also connected to the connection point P6 of the changeover switch SW1 and the buffer amplifier 21 and to a connection point P8 located between the connection points P1 and P2.

In FIG. 5, the supply voltage-dividing resistors R1, R2 and the changeover switch SW1 represent a supply voltage regulator, the ON/OFF switch SW2 represents a voltage dividing resistance regulator, and the control circuit 20 represents a switching controller respectively.

Next, the operation of the temperature detecting device 10 shown in FIG. 5 will be explained.

First, the control circuit 20 estimates the temperature of the thermistor TH (thermistor temperature) based on the voltage at the connection point P8, and determines whether the estimated temperature is in the low-temperature range or in the high-temperature range. When it is determined that the estimated temperature is in the low-temperature range, as shown in FIG. 5, the circuit 20 connects the movable contact 19 of the changeover switch SW1 to the fixed contact 17 and simultaneously, disconnects the movable contact 27 of the ON/OFF switch SW2 from the fixed contact 26 (i.e., opens the ON/OFF switch SW2) by sending control signals. With this, the supply voltage Vsup is applied to the input terminal 25 of the thermistor TH (without being divided (regulated) by the supply voltage-dividing resistors R1, R2) through the buffer amplifier 21, and the thermistor TH is directly connected to the voltage-dividing resistor Rc1. Consequently, the supply voltage Vsup divided by the thermistor TH and the voltage-dividing resistor Rc1 is detected as the output voltage Vout at the connection point P1.

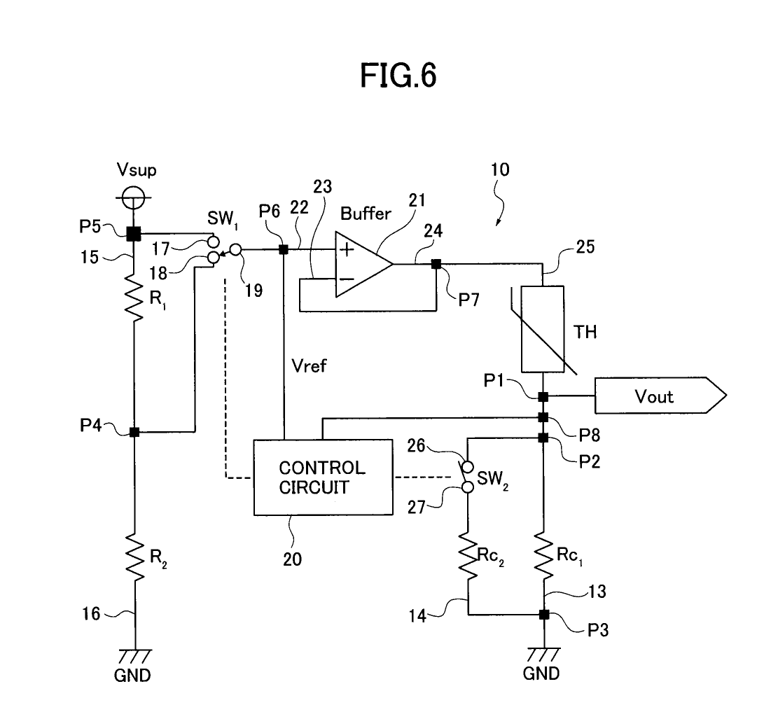

Further, when it is determined that the estimated temperature is in the high-temperature range, as shown in FIG. 6, the circuit 20 connects the movable contact 19 of the changeover switch SW1 to the fixed contact 18 and simultaneously, connects the movable contact 27 of the ON/OFF switch SW2 to the fixed contact 26 (i.e., closes the ON/OFF switch SW2) by sending control signals. With this, the supply voltage Vsup is divided (regulated) by the supply voltage-dividing resistors R1, R2 before being applied to the input terminal 25 of the thermistor TH through the buffer amplifier 21, and the thermistor TH is directly connected to the parallel-connected voltage-dividing resistors Rc1, Rc2. Consequently, the supply voltage Vsup divided by the supply voltage-dividing resistors R1, R2 and further divided by the thermistor TH and the parallel connected voltage dividing-resistors Rc1, Rc2 is detected as the output voltage Vout at the connection point P1.

As explained with the conventional technique, if the same supply voltage is used for both the low-temperature range and the high-temperature range, current flowing through the thermistor TH can exceedingly be increased and can increase the self-heating amount of the thermistor TH in the low-resistance range (in high-temperature range), such that it becomes unable to detect the temperature accurately. To avoid such a disadvantage, it is preferable to appropriately step-down the supply voltage in the low-resistance range.

Therefore, in Embodiment 1, it is configured to apply the voltage to the thermistor TH after dividing (stepping-down) the supply voltage Vsup by the supply voltage-dividing resistors R1, R2 by controlling the changeover switch SW1 to connect the movable contact 19 with the fixed contact 18 when the estimated thermistor temperature is determined to be in the high-temperature range.

Also, it is configured such that the voltage further divided by the resistance of the thermistor TH and the combined resistance of the parallel connected voltage-dividing resistors Rc1, Rc2 is detected as the output voltage Vout when the estimated thermistor temperature is determined to be in the high-temperature range.

In the low-temperature range, when the current value I at the thermistor TH is 10 mA, since the thermistor resistance Rth at the lowest temperature Tmin is 100Ω and the resistance of the voltage-dividing resistor Rc for the low-temperature range is 75Ω (as shown in FIG. 4), the voltage applied (inputted) to the thermistor TH (Vin) becomes:

Vin=I×(Rth+Rc)=0.01×(100+75)=1.75 [V].

On the other hand, in the high-temperature range, in order to keep the current value I at the thermistor TH to 10 mA (the same as the one in the low-temperature range), since the thermistor resistance Rth at the highest temperature Tmax is 30Ω and the resistance of the voltage-dividing resistor Rc for the high-temperature range is 40Ω (as shown in FIG. 4), the voltage applied to the thermistor TH (Vin) needs to be:

Vin=I×(Rth+Rc)=0.01×(30+40)=0.7 [V].

If the voltage applied to the thermistor TH (Vin) is not appropriately decreased at the highest temperature, the current value I at the thermistor TH becomes 25 mA (∵ I=Vin/(Rth+Rc)=1.75/(30+40)=0.025 [A]). Thus, the self-heating amount (an amount of heat transfer) Q at the thermistor TH becomes:

Q=I²Rth=0.025²×30=0.01875 [W], disadvantageously.

However, if the voltage applied to the thermistor TH (Vin) is appropriately decreased (as explained above), the current value I at the thermistor TH remains 10 mA, thereby suppressing the self-heating amount (the amount of heat transfer) Q at the thermistor TH to:

Q=I²Rth=0.01²×30=0.003 [W].

In other words, by appropriately decreasing (stepping down) the voltage applied to the thermistor TH (Vin), it becomes possible to suppress the self-heating of the thermistor TH in the high-temperature range, and thus, it becomes possible to improve the accuracy of detecting the temperature in the high-temperature range (i.e., in the low-resistance range).

The control circuit 20 sets (decides) the reference voltage Vref for AD converting based on the supply voltage Vsup. The control circuit stores information regarding the temperature in relation to the output voltage Vout as a data table or with an operational equation, and uses the data table or the equation to convert (translate) the detected output voltage Vout into temperature.

For example, when the thermistor resistance Rth at 10° C. is 90Ω, and the resistance of the voltage-dividing resistor Rc for the low-temperature range is 75Ω; the output voltage Vout is: Vout=Vin×Rc/(Rth+Rc)=1.75×75/(90+75)≈0.8V. Hence, the temperature information stored in the data table is: when the detected output voltage Vout is 0.8V in the low-temperature range, the temperature is 10° C.

Note that if the reference voltage Vref is set to 1.75V, the digital data of the output voltage Vout is 01110101B in binary number.

Also, when the thermistor resistance Rth at 40° C. is 40 SI, and the resistance of the voltage-dividing resistor Rc for the high-temperature range is 40Ω; the output voltage Vout is: Vout=0.7×40/(40+40)≈0.35V. Hence, the temperature information stored in the data table is: when the detected output voltage Vout is 0.35V in the high-temperature range, the temperature is 40° C.

Note that if the reference voltage Vref is set to 0.7V, the digital data of the output voltage Vout is 10000000B in binary number.

Since the thermistor resistance Rth at the lowest temperature Tmin is, as explained above, 100Ω and the resistance of the voltage-dividing resistor Rc in the low-temperature range is 75Ω, the output voltage Vout at the lowest temperature Tmin becomes 0.75V (∵ Vout=Vin×Rc/(Rth+Rc)=1.75×75/(100+75)).

Also, since the thermistor resistance Rth₀ at the reference temperature T₀ is, as explained above, 50Ω and the resistance of the voltage-dividing resistor Rc in the low-temperature range is 75Ω, the output voltage Vout at the reference temperature T₀ becomes 1.05V (∵ Vout=1.75×75/(50+75)).

In other words, the output voltage Vout varies from 0.75V to 1.05 V in the low-temperature range.

Therefore, as experimental results, the temperature information for the low-temperature range in relation to the output voltage Vout are stored in the data table from 0.75V to 1.05V in every 0.01V in advance.

Similarly, the output voltage Vout at the highest temperature Tmax becomes 0.4V (∵ Vout=0.7×40/(30+40)), and the output voltage Vout at the reference temperature T₀ becomes 0.31V (∵ Vout=0.7×40/(50+40)).

In other words, the output voltage Vout varies from 0.31V to 0.4 V in the high-temperature range.

Therefore, as experimental results, the temperature information for the high-temperature range in relation to the output voltage Vout is stored in the data table from 0.310V to 0.400 in every 0.001V in advance.

Consequently, it becomes possible for the control circuit 20 to retrieve (detect) the thermistor temperature from the data table based on the detected output voltage Vout accurately.

On the other hand, in a case where the control circuit 20 stores the temperature information with an operational equation, the temperature is calculated by using the following equations: Vout=Vin×Rc/[Rth₀·exp{B(1/T)−(1/T₀)}+Rc].

Therefore, in the low-temperature range, the output voltage Vout is calculated as: Vout=1.75×75/[50·exp {B(1/T)−(1/50)}+75], while in the high-temperature range, the output voltage Vout is calculated as: Vout=0.7×40/[50·exp {B(1/T)−(1/50)}+40.

The detected output voltage Vout (i.e., the retrieved or calculated temperature of the thermistor TH) is inputted to the control circuit 20, and used for processing in the ADC of the control circuit 20 and/or outputted to the outside via a communication circuit (not shown).

As explained above, in Embodiment 1, it is configured to determine whether the estimated temperature of the thermistor TH is in the low-temperature range or in the high-temperature range, and to control the switches SW1 and SW2 simultaneously (in synchronization) based on the determination. With this, it becomes possible to detect temperature accurately in a broad range from low temperature to high temperature.

Further, since it enables detection of the temperature in a broad range accurately, it also becomes possible to accurately and efficiently calibrate temperature characteristics (thermal behavior) of a semiconductor and/or passive component, linear expansion coefficient of a mechanical component, etc. inside a device installed with the thermistor TH.

Further, since it is configured to include the supply voltage-dividing resistors R1, R2 together with the switches SW1, SW2 as the supply voltage regulator, it becomes possible to simplify the configuration of the supply voltage regulator.

Further, since the reference voltage Vref is used to AD convert the voltage applied to the thermistor TH (Vin), it becomes possible to convert the voltage into digital data accurately.

### Embodiment 2

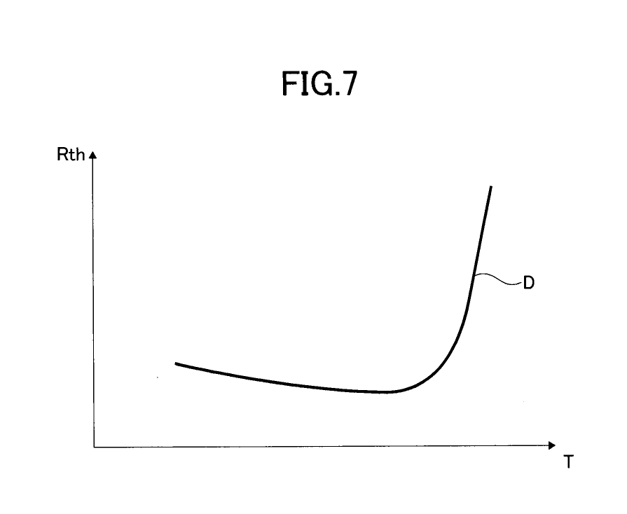

FIGS. 7 to 9 show the configuration of Embodiment 2. In Embodiment 1, as shown in and explained with FIGS. 2 and 3, the changing rate of the thermistor resistance Rth in the low-temperature range is greater than the changing rate of the resistance Rth in the high-temperature range (i.e., the resolution in the low-temperature range is higher than the resolution in the high-temperature range). In contrast, in Embodiment 2, as shown with the curve D in the FIG. 7, the changing rate of the thermistor resistance Rth in the low-temperature range is smaller than the changing rate of the resistance Rth in the high-temperature range (i.e., the resolution in the low-temperature range is lower than the resolution in the high-temperature range). In other words, it is configured to include a positive temperature coefficient thermistor (PTC thermistor) instead of an NTC thermistor.

Except for the thermistor type, the configuration of the temperature detecting device 10 in Embodiment 2 is the same as the configuration in Embodiment 1, but the operation of the switches SW1 and SW2 differs.

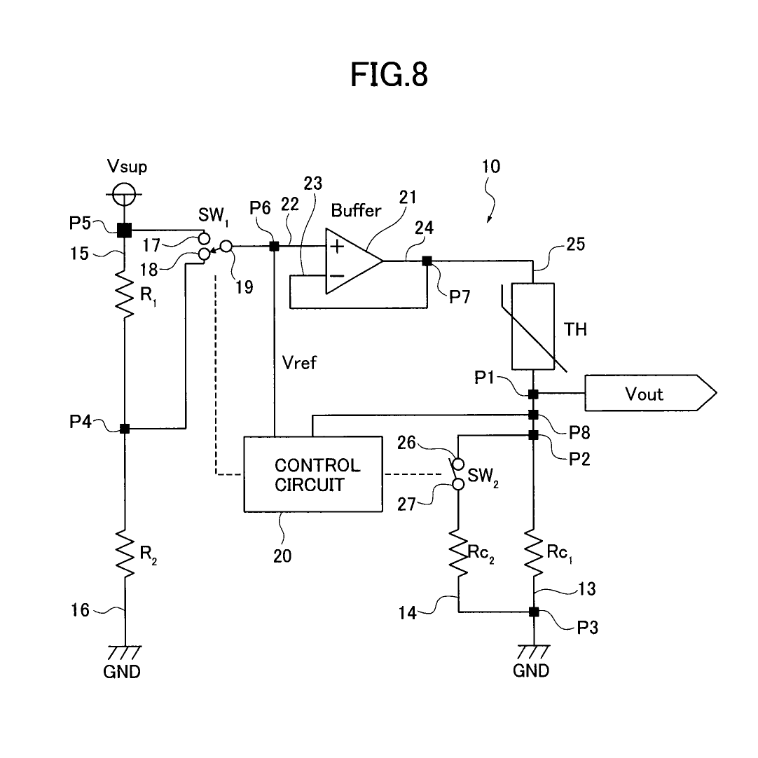

To be specific, as shown in FIG. 8, in Embodiment 2, it is configured to connect the movable contact 19 of the changeover switch SW1 to the fixed contact 18 and to connect the movable contact 27 of the ON/OFF switch SW2 to the fixed contact 26 (i.e., to close the ON/OFF switch SW2) simultaneously when it is determined that the estimated thermistor temperature is in the low-temperature range. With this, the supply voltage Vsup is divided (regulated) by the supply voltage-dividing resistors R1, R2 before being applied to the input terminal 25 of the thermistor TH through the buffer amplifier 21, and the thermistor TH is directly connected to the parallel-connected voltage-dividing resistors Rc1, Rc2. Consequently, the supply voltage Vsup divided by the supply voltage-dividing resistors R1, R2 and further divided by the thermistor TH and the parallel connected voltage dividing-resistors Rc1, Rc2 is detected as the output voltage Vout at the connection point P1.

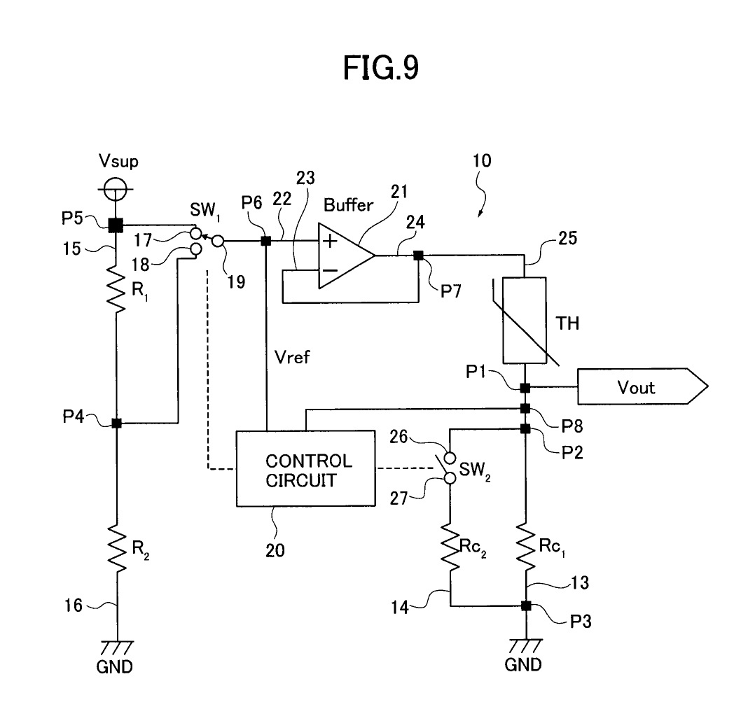

Similarly, as shown in FIG. 9, it is configured to connect the movable contact 19 of the changeover switch SW1 to the fixed contact 17 and to disconnect the movable contact 27 of the ON/OFF switch SW2 from the fixed contact 26 (i.e., to open the ON/OFF switch SW2) simultaneously when it is determined that the estimated thermistor temperature is in the high-temperature range. With this, the supply voltage Vsup is applied to the input terminal 25 of the thermistor TH (without being stepped-down by the supply voltage-dividing resistors R1, R2) thorough the buffer amplifier 21, and the thermistor TH is directly connected to the voltage-dividing resistor Rc1. Consequently, the supply voltage Vsup divided by the thermistor TH and the voltage-dividing resistor Rc1 is detected as the output voltage Vout at the connection point P1.

In Embodiment 2, it is also configured to determine whether the estimated temperature of the thermistor TH is in the low-temperature range or in the high-temperature range, and to control the switches SW1 and SW2 simultaneously (in synchronization) based on the determination. With this, it becomes possible to detect temperature accurately in a broad range from high temperature to low temperature.

Further, since it enables detection of the temperature in a broad range accurately, it also becomes possible to accurately and efficiently calibrate temperature characteristics (thermal behavior) of a semiconductor and/or passive component, linear expansion coefficient of a mechanical component, etc. inside a device installed with the thermistor TH.

Note that although Embodiments 1, 2 are explained to use the changeover switch SW1 and ON/OFF switch SW2, these are only examples and are not limited thereto. Instead, it is possible to use relays, FETs (Field Effect Transistors), or the like as the switching elements.

Further, although the above Embodiments are described to include two phases (levels) controlling the low-temperature range and the high-temperature range, it should not be limited thereto and it is of course possible to include more than two phases (levels) depending on the subject temperature range.

Further, although the above Embodiments are described to include two resistors for each voltage-dividing resistors R1, R2 and Rc1, Rc2, it should not be limited thereto, and it is possible to include more than two resistors for each dividing resistor depending on the design.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. A temperature detecting device including a thermistor and a voltage-dividing resistor directly connected to the thermistor and being adapted to detect temperature based on output voltage at a connection point of the thermistor and the voltage-dividing resistor, the device comprising:
a temperature estimator to estimate temperature of the thermistor;
a supply voltage regulator to regulate voltage supplied from a voltage source to the thermistor;
a voltage dividing resistance regulator to regulate a resistance value of the voltage-dividing resistor; and
a switching controller to determine whether the estimated temperature of the thermistor is in a high-temperature range or in a low-temperature range, and to control the supply voltage regulator and the voltage dividing resistance regulator simultaneously based on the determination.

2. The device according to claim 1, wherein the supply voltage regulator includes a supply voltage-dividing resistor, divides the voltage supplied from the voltage source by the supply voltage-dividing resistor, and outputs the divided voltage to the thermistor.

3. The device according to claim 2, wherein the switching controller controls the supply voltage regulator to step-down the voltage supplied from the voltage source by the supply voltage-dividing resistor, and outputs the stepped-down voltage to the thermistor if the estimated temperature of the thermistor is determined to be in the high-temperature range, when the thermistor has characteristics in which resistance of the thermistor in the high-temperature range is lower than the resistance in the low-temperature range.

4. The device according to claim 2, wherein the switching controller controls the supply voltage regulator to output the voltage supplied from the voltage source to the thermistor without stepping-down the supply voltage if the estimated temperature of the thermistor is determined to be in the low-temperature range, when the thermistor has characteristics in which resistance of the thermistor in the low-temperature range is lower than the resistance in the high-temperature range.

5. The device according to claim 1, wherein the voltage dividing resistance regulator can selectively connect the thermistor with a single voltage-dividing resistor directly or with a plurality of voltage-dividing resistors connected in parallel directly.

6. The device according to claim 5, wherein the switching controller controls the voltage dividing resistance regulator to connect the plurality of the voltage-dividing resistors connected in parallel with the thermistor if the estimated temperature of the thermistor is determined to be in the high-temperature range, when the thermistor has characteristics in which resistance of the thermistor in the high-temperature range is lower than the resistance in the low-temperature range.

7. The device according to claim 5, wherein the switching controller controls the voltage dividing resistance regulator to directly connect the single voltage-dividing resistor with the thermistor if the estimated temperature of the thermistor is determined to be in the low-temperature range, when the thermistor has characteristics in which resistance of the thermistor in the low-temperature range is lower than the resistance in the high-temperature range.

8. The device according to claim 3, wherein the switching controller determines that the estimated temperature of the thermistor is in the high-temperature range based on a reference voltage which is used to convert supply voltage for the thermistor into digital data by an AD converter.

9. The device according to claim 4, wherein the switching controller determines that the estimated temperature of the thermistor is in the low-temperature range based on a reference voltage which is used to convert supply voltage for the thermistor into digital data by an AD converter.

10. The device according to claim 6, wherein the switching controller determines that the estimated temperature of the thermistor is in the high-temperature range based on a reference voltage which is used to convert supply voltage for the thermistor into digital data by an AD converter.

11. The device according to claim 7, wherein the switching controller determines that the estimated temperature of the thermistor is in the low-temperature range based on a reference voltage which is used to convert supply voltage for the thermistor into digital data by an AD converter.
